(19) United States
(12) Patent Application Publication
(10) Pub. No.: US 2016/0279543 A1
(43) Pub. Date: Sep. 29, 2016

(54) Filter Subassembly, Filter Assembly, Filter and Method for Utilizing the Same

(71) Applicant: Wix Filtration Corp LLC, Gastonia, NC (US)

(72) Inventors: Willie L. Stamey, JR., Kings Mountain, NC (US); Mark A. Roll, Bessemer City, NC (US); Gregory K. Rhyne, Stanely, NC (US)

(21) Appl. No.: 14/670,864

(22) Filed: Mar. 27, 2015

(51) Int. Cl. B01D 29/13; B01D 35/30

(52) U.S. Cl. CPC B01D 29/13; B01D 35/30

(57) ABSTRACT

A filter subassembly is disclosed. The filter subassembly includes an end cap connected to a ring of memory material. The end cap includes a tube-shaped body, a first ring-shaped body, a second ring-shaped body and a third ring-shaped body. The tube-shaped body is defined by an inner radial surface, an outer radial surface, a first axial surface and a second axial surface. The inner radial surface defines a passage extending through the tube-shaped body. The first ring-shaped body extends axially away from the first axial surface of the tube-shaped in a first axial direction. The second ring-shaped body extends axially away from a second axial surface of the tube-shaped body in a second axial direction that is opposite the first axial direction. The third ring-shaped body extends axially away from the second axial surface of the tube-shaped body in the second axial direction that is opposite the first axial direction. Each of the first ring-shaped body, the second ring-shaped body and the third ring-shaped body are defined by an inner radial surface, an outer radial surface and an axial surface that connects the inner radial surface to the outer radial surface. One or both of the first axial surface of the tube-shaped body and the inner radial surface of the first ring-shaped body is disposed adjacent the ring of memory material. The second axial surface of the tube-shaped body, the inner radial surface of the second ring-shaped body and the outer radial surface of the third ring-shaped body collectively define a ring-shaped filter media receiving channel. A filer assembly is also disclosed. An assembly is also disclosed. A filter is also disclosed. A method is also disclosed.

### TECHNICAL FIELD

This disclosure relates to a filter subassembly, filter assembly, filter and method for utilizing the same.

### BACKGROUND

Various filters are known in the art for filtering fluid as it passes through a fluid path. Filters include, in part, filter media which removes impurities from a fluid, such as, for example, oil or fuel that passes through filter media.

In most applications, either a filter assembly or the filter media associated therewith must be periodically replaced to reduce the potential of developing unacceptably high impedance in the fluid path flow restriction.

While known filters have proven to be acceptable for various applications, such conventional filters are nevertheless susceptible to improvements that may enhance their overall performance and cost. Therefore, a need exists to develop improved filters and methodologies for forming the same that advance the art.

### SUMMARY

A filter subassembly provides and includes an end cap connected to a ring of memory material. The end cap includes a tube-shaped body, a first ring-shaped body, a second ring-shaped body and a third ring-shaped body. The tube-shaped body is defined by an inner radial surface, an outer radial surface, a first axial surface and a second axial surface. The inner radial surface defines a passage extending through the tube-shaped body. The first ring-shaped body extends axially away from the first axial surface of the tube-shaped in a first axial direction. The second ring-shaped body extends axially away from a second axial surface of the tube-shaped body in a second axial direction that is opposite the first axial direction. The third ring-shaped body extends axially away from the second axial surface of the tube-shaped body in the second axial direction that is opposite the first axial direction. Each of the first ring-shaped body, the second ring-shaped body and the third ring-shaped body are defined by an inner radial surface, an outer radial surface and an axial surface that connects the inner radial surface to the outer radial surface. One or both of the first axial surface of the tube-shaped body and the inner radial surface of the first ring-shaped body is disposed adjacent the ring of memory material. The second axial surface of the tube-shaped body, the inner radial surface of the second ring-shaped body and the outer radial surface of the third ring-shaped body collectively define a ring-shaped filter media receiving channel.

In one configuration, the ring of memory material includes a tube-shaped body defined by an inner radial surface, an outer radial surface, a first axial surface and a second axial surface. The inner radial surface of the tube-shaped body of the ring of memory material defines a passage extending through the tube-shaped body of the ring of memory material. The passage extending through the tube-shaped body of the end cap is in fluid communication with the passage extending through the tube-shaped body of the ring of memory material.

In one configuration, the tube-shaped body of the ring of memory material is defined by a height extending between the first axial surface of the tube-shaped body of the ring of memory material and a second axial surface of the tube-shaped body of the ring of memory material. The first ring-shaped body is defined by a height extending between the first axial surface of the tube-shaped body of the end cap and the axial surface of the first ring-shaped body. The height of the tube-shaped body of the ring of memory material is greater than the height of the first ring-shaped body such that a circumferential portion of the outer radial surface of the tube-shaped body of the ring of memory material extends axially beyond the axial surface of the first ring-shaped body.

In one configuration, the inner radial surface of the first ring-shaped body defines a passage extending through the first ring-shaped body. The ring of memory material is partially disposed within the passage extending through the first ring-shaped body. The ring of memory material defines a height dimension that is greater than a height dimension of the first ring-shaped body such that when the ring of memory material is connected to the end cap, a circumferential portion of the outer radial surface of the tube-shaped body of the ring of memory material extends axially beyond the axial surface of the first ring-shaped body.

In one configuration, the inner radial surface of the first ring-shaped body defines a passage extending through the first ring-shaped body. The passage extending through the first ring-shaped body is defined by a diameter. The outer radial surface of the tube-shaped body of the ring of memory material defines an outer diameter of the tube-shaped body of the ring of memory material. The outer diameter of the tube-shaped body of the ring of memory material is approximately equal to but less than the diameter of the passage extending through the first ring-shaped body.

In one configuration, a circumferential portion of the second axial surface of the tube-shaped body of the ring of memory material is arranged in a cantilevered orientation with respect to the first axial surface of the tube-shaped body of the end cap.

In one configuration, the outer radial surface of the first ring-shaped body and the outer radial surface of the second ring-shaped body are connected to and axially aligned with the outer radial surface of the tube-shaped body of the end cap.

In one configuration, the inner radial surface of the third ring-shaped body is connected to and is aligned with the inner radial surface of the tube-shaped body of the end cap.

In one configuration, the inner radial surface of the third ring-shaped body defines a passage extending through the third ring-shaped body. The passage extending through the third ring-shaped body is axially aligned with and is in fluid communication with the passage extending through the tube-shaped body of the end cap.

In another configuration, a filter assembly is provided and includes filter media, a first filter subassembly including a first end cap connected to a first ring of memory material and a second filter subassembly including a second end cap connected to a second ring of memory material. The filter media includes a tube-shaped body defined by an inner radial surface, an outer radial surface, a first axial surface and a second axial surface. The inner radial surface defines a passage extending through the tube-shaped body of filter media. The first axial surface and a portion of each of the inner radial surface and the outer radial surface extending from the first axial surface defines a first end of the tube-shaped body of filter media. The second axial surface and a portion of each of the inner radial surface and the outer radial surface extending from the second axial surface defines a second end of the tube-shaped body of filter media. The first filter subassembly is disposed adjacent the first end of the tube-shaped body of the filter media. The second filter subassembly is disposed adjacent the second end of the tube-shaped body of the filter media.

In one configuration, the first end of the tube-shaped body of the filter media is disposed within and connected to the ring-shaped filter media receiving channel of the first filter subassembly. The second end of the tube-shaped body of the filter media is disposed within and connected to the ring-shaped filter media receiving channel of the second filter subassembly.

In one configuration, the filter assembly may additionally include a center tube. The center tube is disposed within the passage extending through the tube-shaped body of the filter media. The center tube is disposed substantially adjacent the inner radial surface of the tube-shaped body of the filter media. The center tube includes a plurality of radial fluid-flow passages.

In yet another configuration, an assembly is provided and includes a lid connected to a filter assembly. The lid includes a holder that is mounted to an inner axial surface of the lid. The holder includes a central ring portion that terminates with a plurality of catch hooks each having a radially-outwardly-projecting flexible catch nose. The central ring portion is disposed within a passage extending through a tube-shaped body defining a ring of memory material of a first filter subassembly of the filter assembly. The radially-outwardly-projecting flexible catch nose of each catch hook of the plurality of catch hooks is disposed adjacent a circumferential portion of a second axial surface of the tube-shaped body of the ring of memory material of the first filter subassembly. The circumferential portion of the second axial surface of the tube-shaped body of the ring of memory material of the first filter subassembly is arranged in a cantilevered orientation with respect to the first axial surface of the tube-shaped body of the end cap of the first filter subassembly.

In even yet another configuration, a filter is provided and includes a housing, a lid and a filter assembly. The housing includes a substantially cylindrical body defining a passage. The lid is connected to the housing. The filter assembly is disposed within the passage defined by the substantially cylindrical body of the housing.

In one configuration, a tube-shaped body defining a ring of memory material of a second filter subassembly of the filter assembly engages and conforms to a surface profile of a tube-shaped stem portion extending through a lower opening of the substantially cylindrical body of the housing.

In one configuration, a portion of the tube-shaped body of the ring of memory material of the second filter subassembly is axially lowered into and conforms to and fills and seals an opening defined by the tube-shaped stem portion that is in fluid communication with a secondary discharge conduit.

In another configuration, a method is provided and includes: assembling a filter assembly by arranging a first subassembly including a first end cap connected to a first ring of memory material adjacent a first end of a tube-shaped body of filter media and arranging a second subassembly including a second end cap connected to a second ring of memory material adjacent a second end of the tube-shaped body of the filter media; removably-connecting the filter assembly to a lid by joining the lid to the first subassembly of the filter assembly; while the lid is connected to the filter assembly, axially disposing the filter assembly into an upper opening defined by a passage of a housing by firstly inserting the second subassembly through the upper opening and into the passage defined by the housing and subsequently rotatably-connecting the lid to the housing; as the lid is rotatably-connected to the housing, the second ring of memory material of the second subassembly is further axially advanced into the passage defined by the housing for engaging and conforming to a surface profile of a tube-shaped stem portion extending through a lower opening of the housing for conforming to and filling and sealing at least one lower opening of a plurality of lower openings defined in part by the tube-shaped stem portion that is in fluid communication with a secondary discharge conduit.

In one configuration, the method may additionally include: disposing a central ring portion that extends from inner axial surface of the lid within a passage extending through a tube-shaped body defining the first ring of memory material; and disposing a radially-outwardly-projecting flexible catch nose of each catch hook of a plurality of catch hooks extending from the central ring portion adjacent a circumferential portion of a second axial surface of the tube-shaped body of the first ring of memory material. The circumferential portion of the second axial surface of the tube-shaped body of the first ring of memory material is arranged in a cantilevered orientation with respect to a first axial surface of a tube-shaped body of the first end cap.

In one configuration, the plurality of lower openings includes a first lower opening, a second lower opening and a third lower opening. The second ring of memory material of the second subassembly conforms to and fills and seals the third lower opening. The first lower opening permits the passage defined by the housing to be in fluid communication with a clean fluid discharge conduit. The second lower opening permits the passage defined by the housing to be in fluid communication with an unclean fluid intake conduit. The third lower opening permits the passage defined by the housing to be in fluid communication with the secondary discharge conduit secondary discharge conduit.

In one configuration, the tube-shaped stem portion includes a spiral ramp that circumscribes the first lower opening. The second ring of memory material of the second subassembly engages and conforms to a surface profile of the spiral ramp as the second ring of memory material of the second subassembly is further axially advanced into the passage defined by the housing as a result of the lid being rotatably-connected to the housing.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is an exploded perspective view of a filter assembly.

FIG. 2 is a cross-sectional view of the filter assembly of FIG. 1 according to line 2-2.

FIG. 3 illustrates a portion of the filter assembly of FIG. 2.

FIG. 4 is an assembled front view of the filter assembly of FIG. 1.

FIG. 5 is a cross-sectional view of the filter assembly according to line 5-5 of FIG. 4.

FIG. 6 is an exploded cross-sectional view of a filter assembly container including a housing and a lid.

FIG. 7 is a partial side and cross-sectional view of the housing of FIG. 6.

FIG. 8 is a perspective view of a lower end of the housing of FIG. 6.

FIG. 9 is a top view of the lower end of the housing of FIG. 8 according to arrow 9.

FIGS. 10A-10J are views of disposing within, utilizing and subsequently removing the filter assembly of FIG. 5 with respect to the filter assembly container of FIG. 6.

FIG. 11 is a cross-sectional view of the filter assembly of FIGS. 10E-10J after being removed from a housing of the filter assembly container of FIG. 6 and being subsequently detached from a lid of the filter assembly container of FIG. 6.

Like reference symbols in the various drawings indicate like elements.

### DETAILED DESCRIPTION

A filter assembly includes, in part, filter media which removes impurities from a fluid, such as, for example, oil or fuel that passes through filter media. The filter assembly also includes opposing end caps. A subassembly of the filter assembly includes each opposing end cap and a ring of memory material disposed thereupon. Inclusion of the memory material results in the filter assembly being universally disposable in a number of filter assembly containers having unique surface profiles that may be designed to accommodate other specifically-designed filter assemblies.

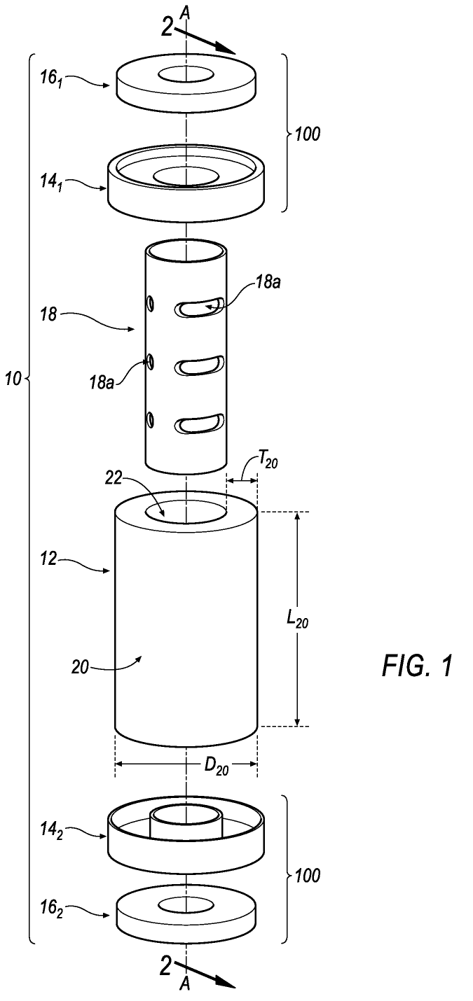

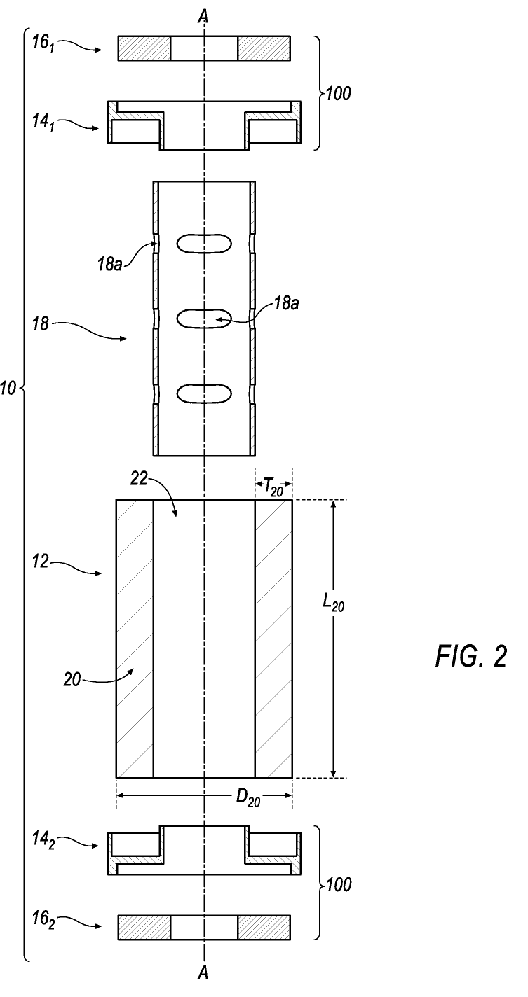

Referring to FIGS. 1-2 and 4-5, an exemplary filter assembly is shown generally at 10. The filter assembly 10 includes filter media 12, a first end cap 14₁, a second end cap 14₂, a first ring of memory material 16₁ and a second ring of memory material 16₂. The filter assembly 10 may optionally include a center tube 18. The filter media 12 may include any desirable geometry such as, for example, a tube-shaped body 20 defined by a length dimension L₂₀, an outer diameter D₂₀ and a radial thickness dimension T₂₀.

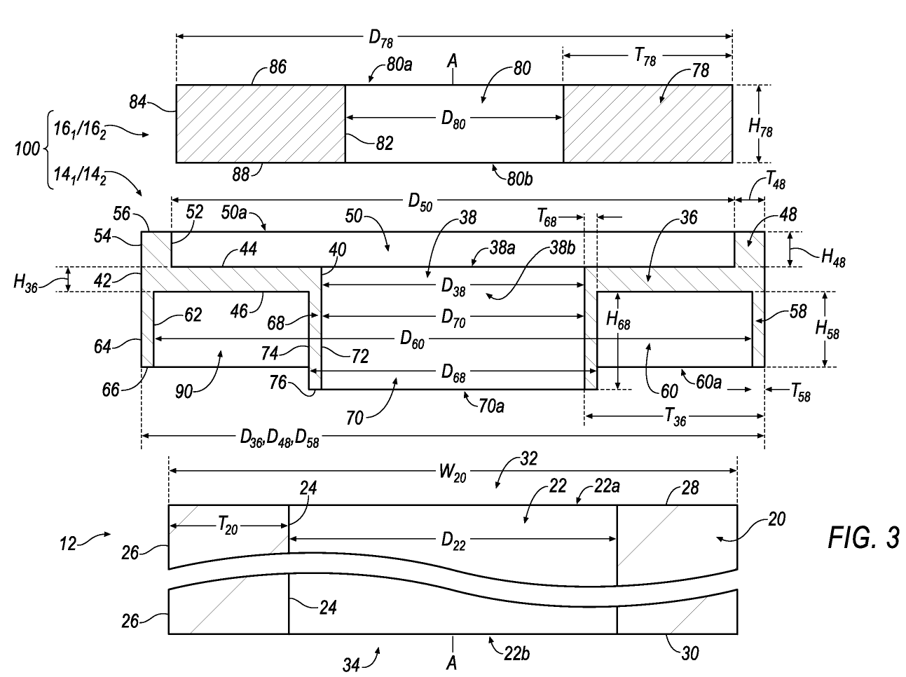

Referring to FIG. 3, a passage 22 defined by a passage diameter D₂₂ extends through the tube-shaped body 20 and is defined by an inner radial surface 24. Access to the passage 22 is permitted by a first opening 22a or a second opening 22b. The first opening 22a and the second opening 22b are each defined by a dimension that is approximately equal to the diameter dimension D₂₂ of the passage 22 extending through the tube-shaped body 20 of the filter media 12. The tube-shaped body 20 is also defined by an outer radial surface 26, a first axial surface 28 and a second axial surface 30. The first opening 22a is formed by the first axial surface 28. The second opening 22b is formed by the second axial surface 30.

Both of the first axial surface 28 and the second axial surface 30 connect the inner radial surface 24 to the outer radial surface 26. The first axial surface 28 and a portion of each of the inner radial surface 24 and the outer radial surface 26 extending from the first axial surface 28 generally defines a first end 32 of the tube-shaped body 20. The second axial surface 30 and a portion of each of the inner radial surface 24 and the outer radial surface 26 extending from the second axial surface 30 generally defines a second end 34 of the tube-shaped body 20.

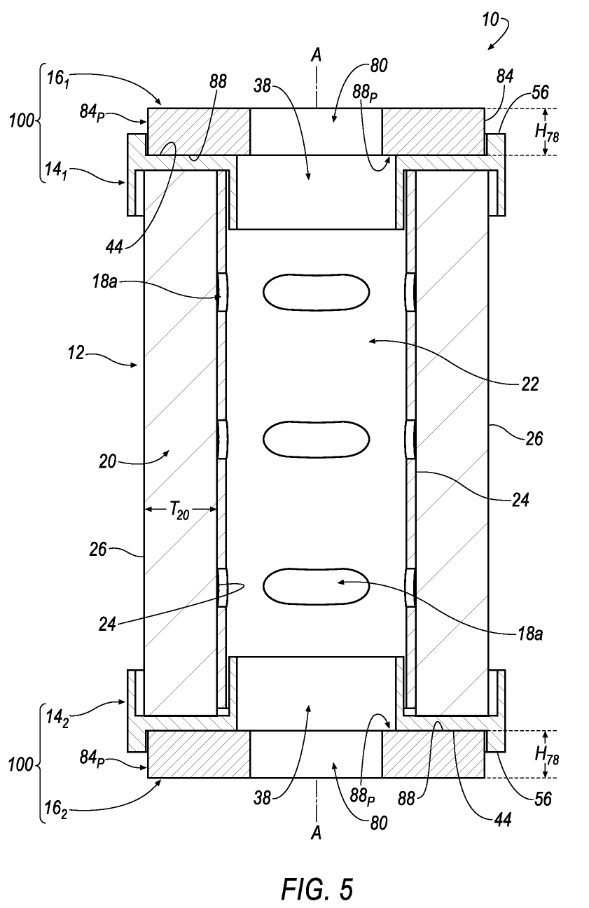

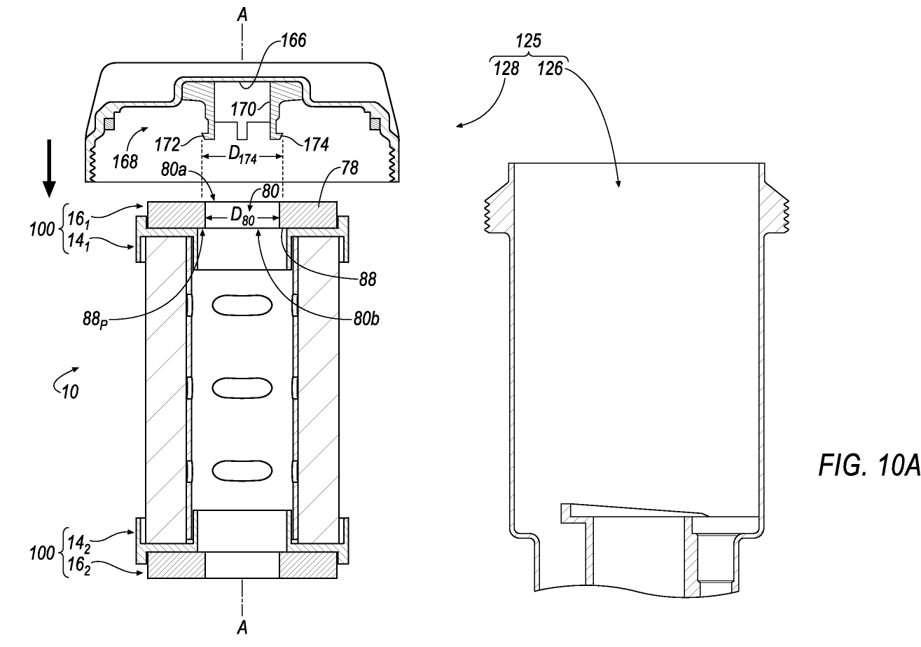

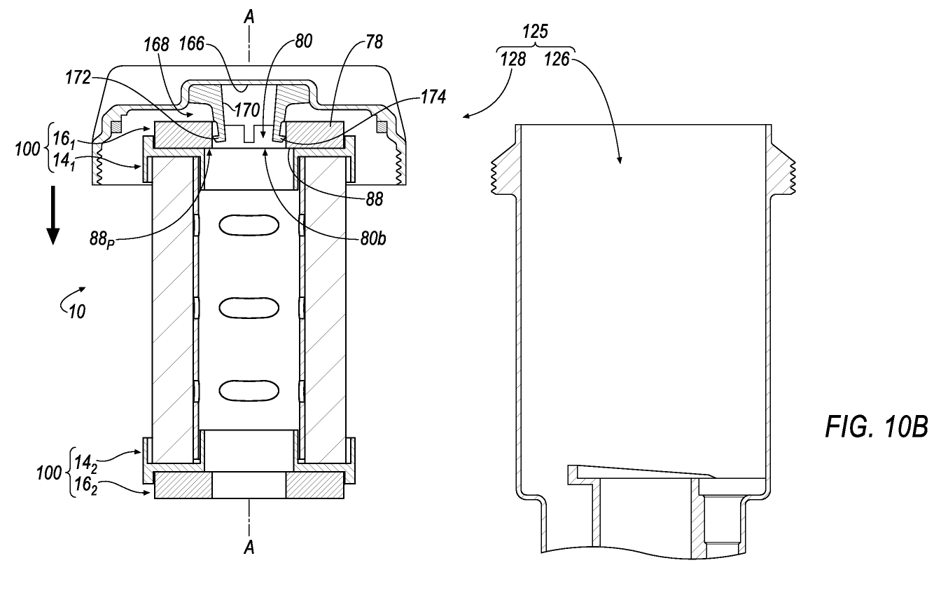

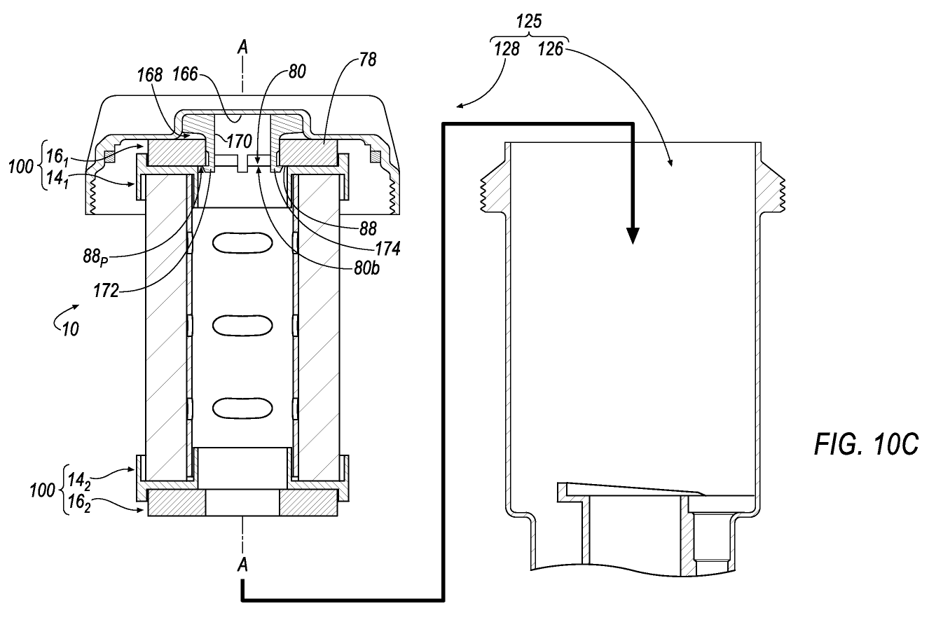

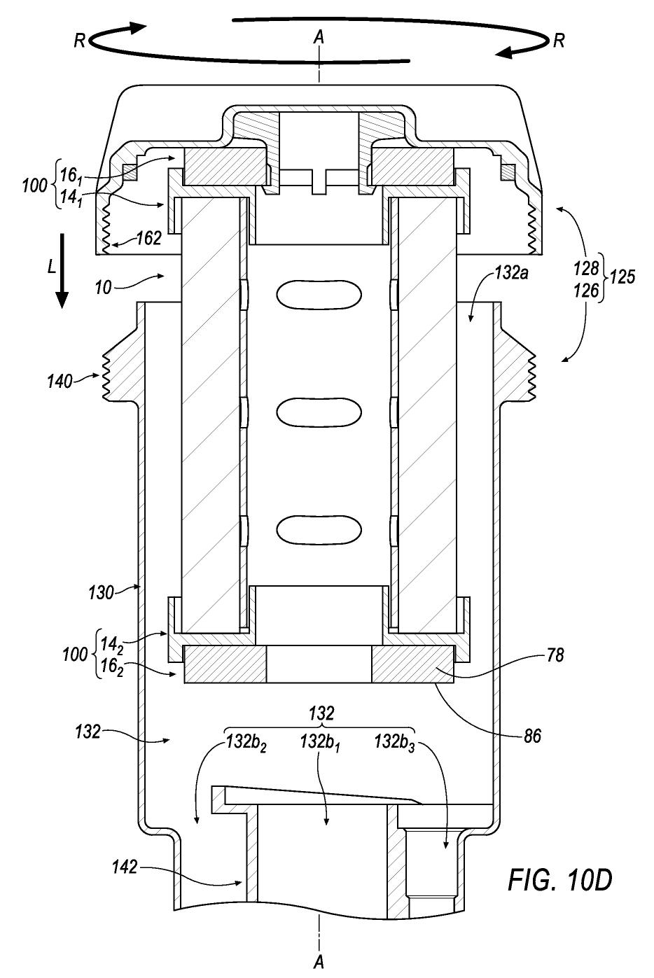

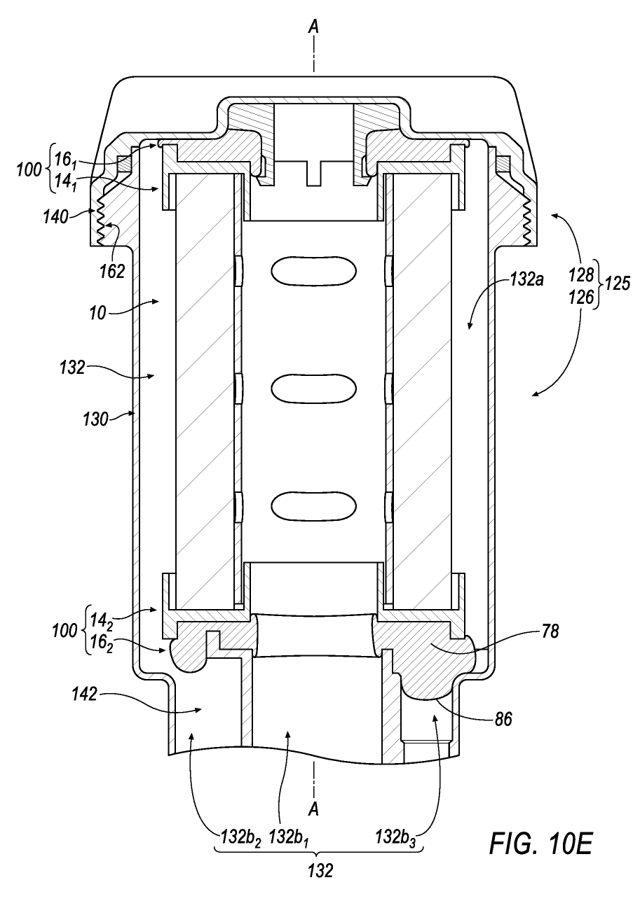

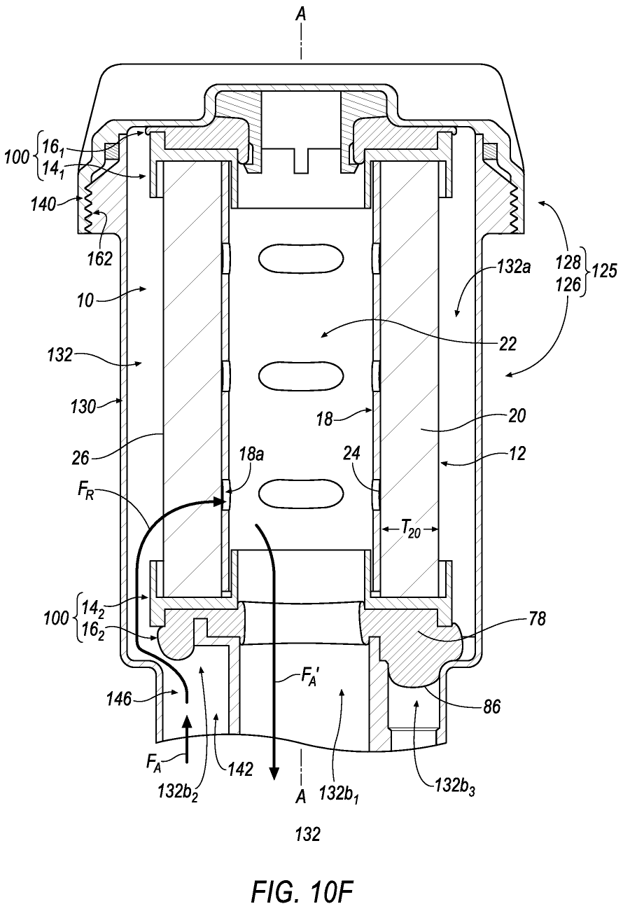

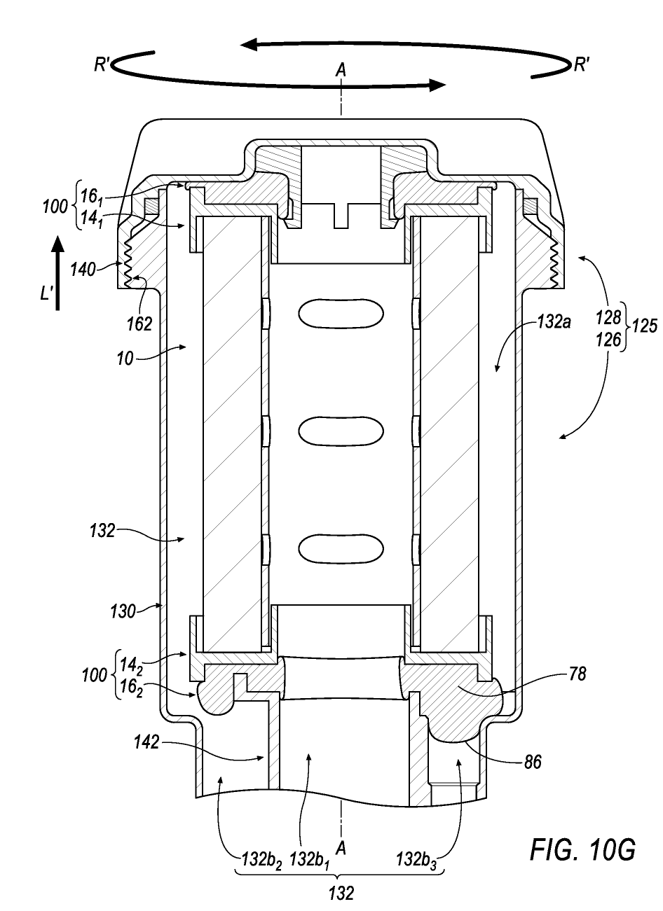

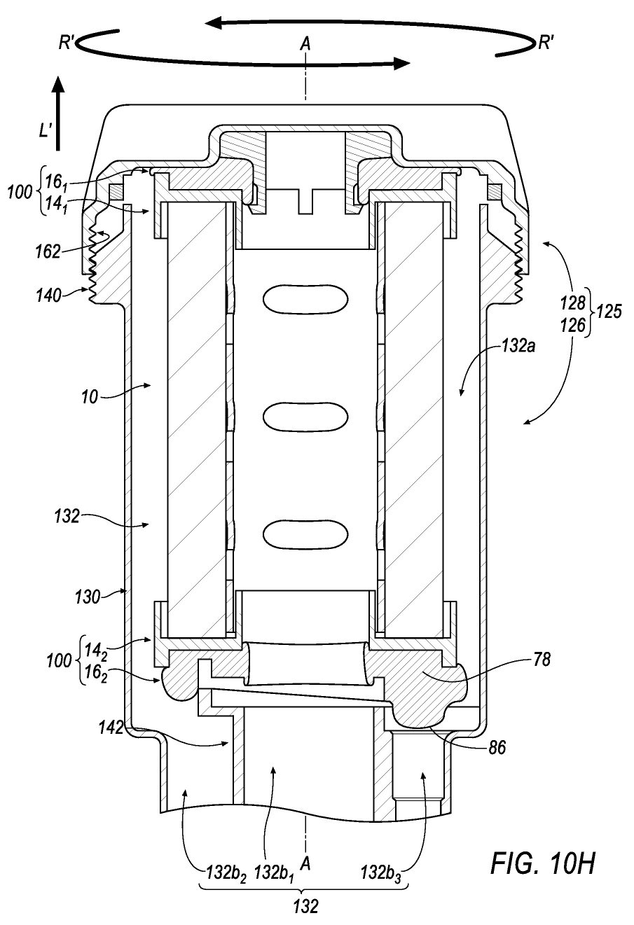

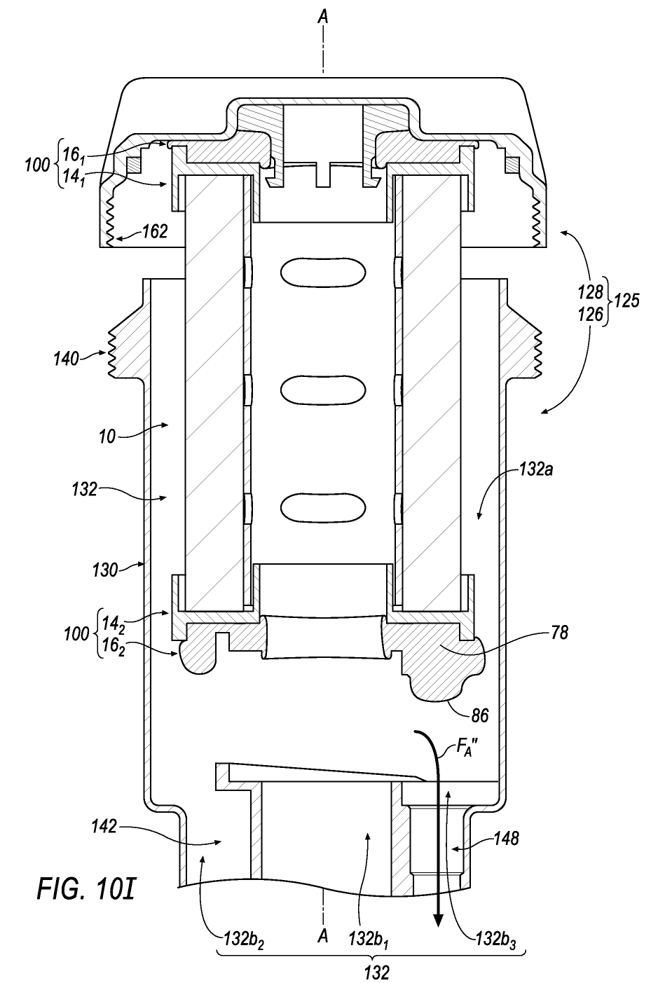

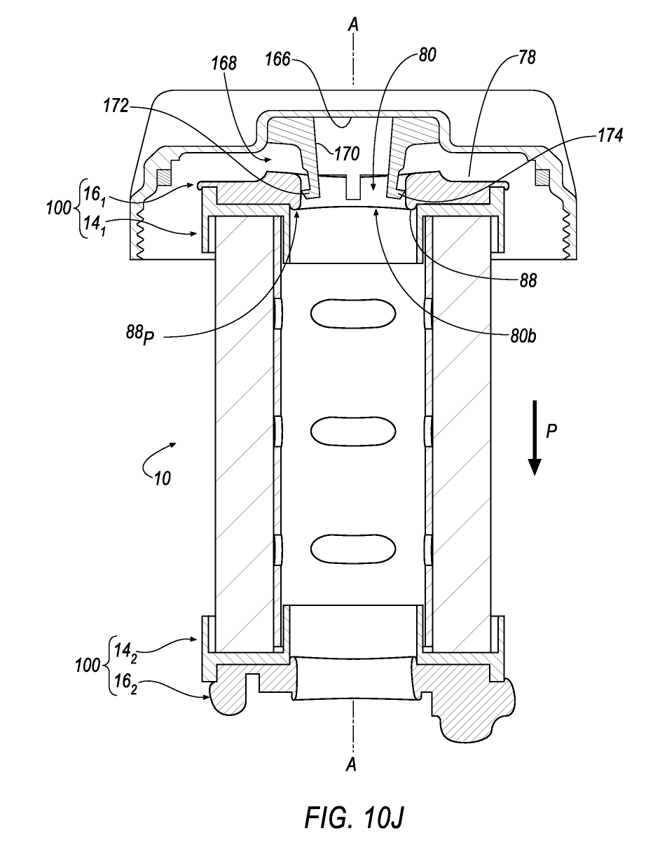

Referring to FIGS. 1-2 and 5, if the filter assembly 10 includes the center tube 18, the center tube 18 may be disposed within the passage 22 and directly adjacent the inner radial surface 24 of the tube-shaped body 20 of the filter media 12. Functionally, the center tube 18 may rigidify the tube-shaped body 20 of the filter media 12. The center tube 18 may also include a plurality of radial passages 18a. With reference to FIG. 5, the plurality of radial passages 18a permits radial fluid flow, F_{R} (see, e.g., FIG. 10F): (1) from the outer radial surface 26 of the tube-shaped body 20 of the filter media 12, (2) through the radial thickness dimension T₂₀ of the tube-shaped body 20 of the filter media 12, (3) out of the inner radial surface 24 of the tube-shaped body 20 of the filter media 12, (4) through the plurality of radial passages 18a of the center tube 18, and (5) into the passage 22 formed by the tube-shaped body 20 of the filter media 12.

Referring to FIGS. 1-5, the filter assembly 10 also includes a subassembly seen generally at 100. The subassembly 100 is defined by the first end cap 14₁ connected to the first ring of memory material 16₁ or the second end cap 14₂ connected to the second ring of memory material 16₂. The first end cap 14₁ and the second end cap 14₂ may have substantially similar shapes and dimensions, and, similarly, the first ring of memory material 16₁ and the second ring of memory material 16₂ may have substantially similar shapes and dimension. As a result of the similarities of the first end cap 14₁ & the second end cap 14₂ and the first ring of memory material 16₁ & the second ring of memory material 16₁, during mass production of a plurality of subassemblies 100, one type of end cap (defined by the first end cap 14₁ & the second end cap 14₂) may be utilized and one type of ring of memory material (defined by the first ring of memory material 16₁ & the second ring of memory material 16₂) may be utilized.

Referring to FIG. 3, each of the first end cap 14₁ and the second end cap 14₂ may include any desirable geometry such as, for example, a tube-shaped body 36 defined by an outer diameter D₃₆, a height dimension H₃₆ and a radial thickness dimension T₃₆. A passage 38 defined by a passage diameter D₃₈ extends through the tube-shaped body 36 and is defined by an inner radial surface 40 of the tube-shaped body 36. The tube-shaped body 36 is also defined by an outer radial surface 42, a first axial surface 44 and a second axial surface 46. Access to the passage 38 is permitted by a first opening 38a or a second opening 38b.

A first ring-shaped body 48 extends from the tube-shaped body 36 of the first end cap 14₁/the second end cap 14₂. The first ring-shaped body 48 is defined by an outer diameter D₄₈, a height dimension H₄₈ and a radial thickness dimension T₄₈. The height dimension H₄₈ may be greater than the radial thickness dimension T₄₈. The outer diameter D₄₈ of the first ring-shaped body 48 may be approximately equal to the outer diameter D₃₆ of the tube-shaped body 36. The first ring-shaped body 48 extends axially away from the first axial surface 44 of the tube-shaped body 36 of the first end cap 14₁/the second end cap 14₂ at a distance approximately equal to the height dimension H₄₈ of the first ring-shaped body 48.

A passage 50 defined by a passage diameter D₅₀ extends through the first ring-shaped body 48 and is defined by an inner radial surface 52 of the first ring-shaped body 48. The first ring-shaped body 48 is also defined by an outer radial surface 54 and an axial surface 56 that connects the inner radial surface 52 to the outer radial surface 54.

Access to the passage 50 is permitted by an opening 50a. The opening 50a is defined by a dimension that is approximately equal to the diameter D₅₀ of the passage 50 extending through the first ring-shaped body 48.

The inner radial surface 52 of the first ring-shaped body 48 is connected to and extends substantially perpendicularly from the first axial surface 44 of the tube-shaped body 36 of the first end cap 14₁/the second end cap 14₂. The outer radial surface 54 of the first ring-shaped body 48 is connected to and is aligned with the outer radial surface 42 of the tube-shaped body 36 of the first end cap 14₁/the second end cap 14₂. The passage 50 extending through the first ring-shaped body 48 is axially aligned with and is in fluid communication with the passage 38 extending through the tube-shaped body 36 of the first end cap 14₁/the second end cap 14₂ by way of the first opening 38a of the passage 38 extending through the tube-shaped body 36 of the first end cap 14₁/the second end cap 14₂.

A second ring-shaped body 58 extends from the tube-shaped body 36 of the first end cap 14₁/the second end cap 14₂. The second ring-shaped body 58 is defined by an outer diameter D₅₈, a height dimension H₅₈ and a radial thickness dimension T₅₈. The height dimension H₅₈ may be greater than the radial thickness dimension T₅₈. The outer diameter D₅₈ of the second ring-shaped body 58 may be approximately equal to both of the outer diameter D₄₈ of the first ring-shaped body 48 and the outer diameter D₃₆ of the tube-shaped body 36.

A passage 60 defined by a passage diameter D₆₀ extends through the second ring-shaped body 58 and is defined by an inner radial surface 62 of the second ring-shaped body 58. The second ring-shaped body 58 is also defined by an outer radial surface 64 and an axial surface 66 that connects the inner radial surface 62 to the outer radial surface 64. Access to the passage 60 is permitted by a first opening 60a. The second ring-shaped body 58 extends axially away from the second axial surface 46 of the tube-shaped body 36 of the first end cap 14₁/the second end cap 14₂ at a distance approximately equal to the height dimension H₅₈ of the second ring-shaped body 58.

The inner radial surface 62 of the second ring-shaped body 58 is connected to and extends substantially perpendicularly from the second axial surface 46 of the tube-shaped body 36 of the first end cap 14₁/the second end cap 14₂. The outer radial surface 64 of the second ring-shaped body 58 is connected to and is aligned with the outer radial surface 42 of the tube-shaped body 36 of the first end cap 14₁/the second end cap 14₂.

A third ring-shaped body 68 extends from the tube-shaped body 36 of the first end cap 14₁/the second end cap 14₂. The third ring-shaped body 68 is defined by an outer diameter D₆₈, a height dimension H₆₈ and a radial thickness dimension T₆₈. The height dimension H₆₈ may be greater than the radial thickness dimension T₆₈. The outer diameter D₆₈ of the third ring-shaped body 68 is less than all of the outer diameter D₄₈ of the first ring-shaped body 48, the outer diameter D₅₈ of the second ring-shaped body 58 and the outer diameter D₃₆ of the tube-shaped body 36.

A passage 70 defined by a passage diameter D₇₀ extends through the third ring-shaped body 68 and is defined by an inner radial surface 72 of the third ring-shaped body 68. The third ring-shaped body 68 is also defined by an outer radial surface 74 and an axial surface 76 that connects the inner radial surface 72 to the outer radial surface 74.

Access to the passage 70 is permitted by a first opening 70a. The first opening 70a is defined by a dimension that is approximately equal to the diameter dimension D₇₀ of the passage 70 extending through the third ring-shaped body 68.

The third ring-shaped body 68 extends axially away from the second axial surface 46 of the tube-shaped body 36 of the first end cap 14₁/the second end cap 14₂ at a distance approximately equal to the height dimension H₆₈ of the third ring-shaped body 68. The height dimension H₆₈ of the third ring-shaped body 68 may be greater than the height dimension H₅₈ of the second ring-shaped body 58.

The outer radial surface 74 of the third ring-shaped body 68 is connected to and extends substantially perpendicularly from the second axial surface 46 of the tube-shaped body 36 of the first end cap 14₁/the second end cap 14₂. The inner radial surface 72 of the third ring-shaped body 68 is connected to and is aligned with the inner radial surface 40 of the tube-shaped body 36 of the first end cap 14₁/the second end cap 14₂. The passage 70 extending through the third ring-shaped body 68 is axially aligned with and is in fluid communication with the passage 38 extending through the tube-shaped body 36 of the first end cap 14₁/the second end cap 14₂ by way of the second opening 38b of the passage 38 extending through the tube-shaped body 36 of the first end cap 14₁/the second end cap 14₂.

As seen in FIG. 3, the outer radial surface 54 of the first ring-shaped body 48 and the outer radial surface 64 of the second ring-shaped body 58 are connected to and aligned with the outer radial surface 42 of the tube-shaped body 36 of the first end cap 14₁/the second end cap 14₂. As a result, the first ring-shaped body 48 may form a first outer circumferential skirt of the tube-shaped body 36 of the first end cap 14₁/the second end cap 14₂, and, the second ring-shaped body 58 may form a second outer circumferential skirt of the tube-shaped body 36 of the first end cap 14₁/the second end cap 14₂. The height dimension H₄₈ of the first ring-shaped body 48 may be less than the height dimension H₅₈ of the second ring-shaped body 58. The radial thickness dimension T₄₈ of the first ring-shaped body 48 may be greater than the radial thickness dimension T₅₈ of the second ring-shaped body 58. As will be described in the following disclosure the radial thickness dimensions T₄₈, T₅₈ are specifically designed to respectively receive the first ring of memory material 16₁/the second ring of memory material 16₂ and the filter media 12.

Referring to FIG. 3, each of the first ring of memory material 16₁ and the second ring of memory material 16₂ may include any desirable geometry such as, for example, a tube-shaped body 78 defined by an outer diameter D₇₈, a height dimension H₇₈ and a radial thickness dimension T₇₈. A passage 80 defined by a passage diameter D₈₀ extends through the tube-shaped body 78 and is defined by an inner radial surface 82. The tube-shaped body 78 is also defined by an outer radial surface 84, a first axial surface 86 and a second axial surface 88. Access to the passage 80 is permitted by a first opening 80a or a second opening 80b.

Functionally, the relative dimensions of the first ring-shaped body 48 of the first end cap 14₁/the second end cap 14₂ and the first ring of memory material 16₁/the second ring of memory material 16₂ results in the first ring-shaped body 48 axially centering the first ring of memory material 16₁/the second ring of memory material 16₂ upon the first axial surface 44 of the tube-shaped body 36 of the first end cap 14₁/the second end cap 14₂. With reference to FIG. 3, the outer diameter D₇₈ of the first ring of memory material 16₁/the second ring of memory material 16₂ may be approximately equal to but slightly less than the passage diameter D₅₀ defining passage 50 that extends through the first ring-shaped body 48. As the first ring of memory material 16₁/the second ring of memory material 16₂ enters the passage 50, the outer radial surface 84 of the first ring of memory material 16₁/the second ring of memory material 16₂ may be arranged directly opposite or directly adjacent the inner radial surface 52 of the first ring-shaped body 48. The first ring of memory material 16₁/the second ring of memory material 16₂ may be said to be connected to the first end cap 14₁/the second end cap 14₂ (thereby forming the subassembly 100) once the second axial surface 88 of the first ring of memory material 16₁/the second ring of memory material 16₂ is disposed adjacent the first axial surface 44 of the tube-shaped body 36 (or, alternatively, once the first ring of memory material 16₁/the second ring of memory material 16₂ enters the passage 50).

In some instances, the first ring of memory material 16₁/the second ring of memory material 16₂ may be connected to the first end cap 14₁/the second end cap 14₂ in a friction-fit connection (i.e., one or more of the outer radial surface 84 and the second axial surface 88 of the first ring of memory material 16₁/the second ring of memory material 16₂ may be disposed tightly adjacent the inner radial surface 54 and the first axial surface 44 of the tube-shaped body 36). Alternatively, or, in addition to the friction-fit connection described above, one or more of the outer radial surface 84 and the second axial surface 88 of the first ring of memory material 16₁/the second ring of memory material 16₂ may be non-removably-secured to the inner radial surface 52 and the first axial surface 44 of the tube-shaped body 36 with, for example, an adhesive (e.g., an epoxy resin).

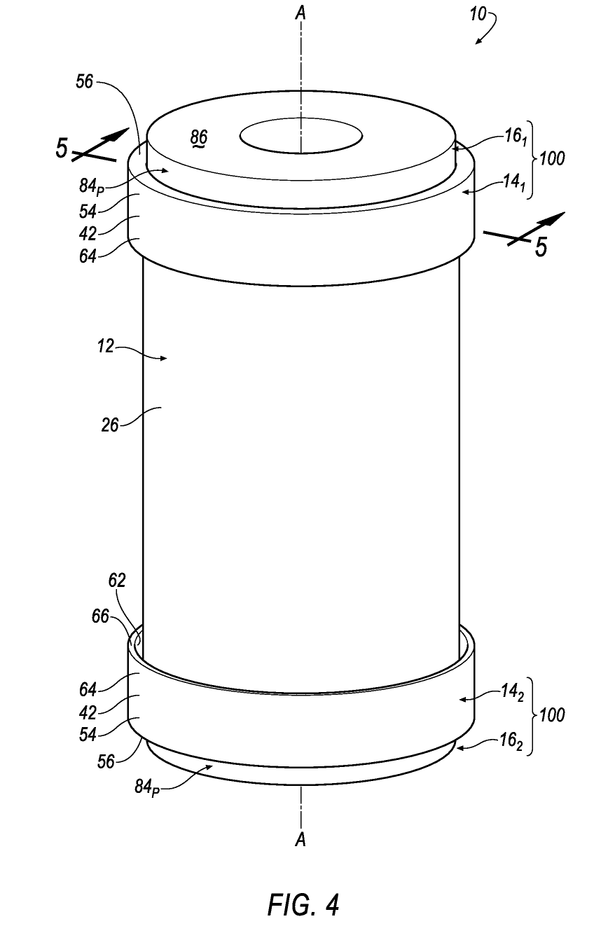

As seen in FIG. 5, once the subassembly 100 is formed, a circumferential portion 88p of the second axial surface 88 of the first ring of memory material 16₁/the second ring of memory material 16₂ is arranged in a cantilevered orientation with respect to the first axial surface 44 of the tube-shaped body 36. Similarly, as seen in FIGS. 4-5, once the subassembly 100 is formed, a circumferential portion 84p of the outer radial surface 84 of the tube-shaped body 78 extends axially beyond the axial surface 56 of the first ring-shaped body 48 and is not arranged opposite or adjacent the inner radial surface 52 of the first ring-shaped body 48 as a result of the height dimension H₇₈ of the first ring of memory material 16₁/the second ring of memory material 16₂ being greater than the height dimension H₄₈ of the first ring-shaped body 48.

With continued reference to FIG. 3, collectively, the second axial surface 46 of the tube-shaped body 36, the inner radial surface 62 of the second ring-shaped body 58 and the outer radial surface 74 of the third ring-shaped body 68 form a ring-shaped filter media receiving channel 90. The ring-shaped filter media receiving channel 90 is sized for receiving either the first end 32 of the tube-shaped body 20 of the filter media 12 or the second end 34 of the tube-shaped body 20 of the filter media 12.

In some instances, first axial surface 28 of the tube-shaped body 20 of the filter media 12 or the second axial surface 30 of the tube-shaped body 20 of the filter media 12 may be connected to one or more of the surfaces 46, 62, 74 defining the ring-shaped filter media receiving channel 90 in a friction-fit connection (i.e., either the first end 32 of the tube-shaped body 20 of the filter media 12 or the second end 34 of the tube-shaped body 20 of the filter media 12 may be disposed tightly adjacent the surfaces 46, 62, 74 defining the ring-shaped filter media receiving channel 90). Alternatively, or, in addition to the friction-fit connection described above, the first end 32 of the tube-shaped body 20 of the filter media 12 or the second end 34 of the tube-shaped body 20 of the filter media 12 may be non-removably-secured to one or more of the surfaces 46, 62, 74 defining the ring-shaped filter media receiving channel 90 with, for example, a urethane adhesive (e.g., plastisol).

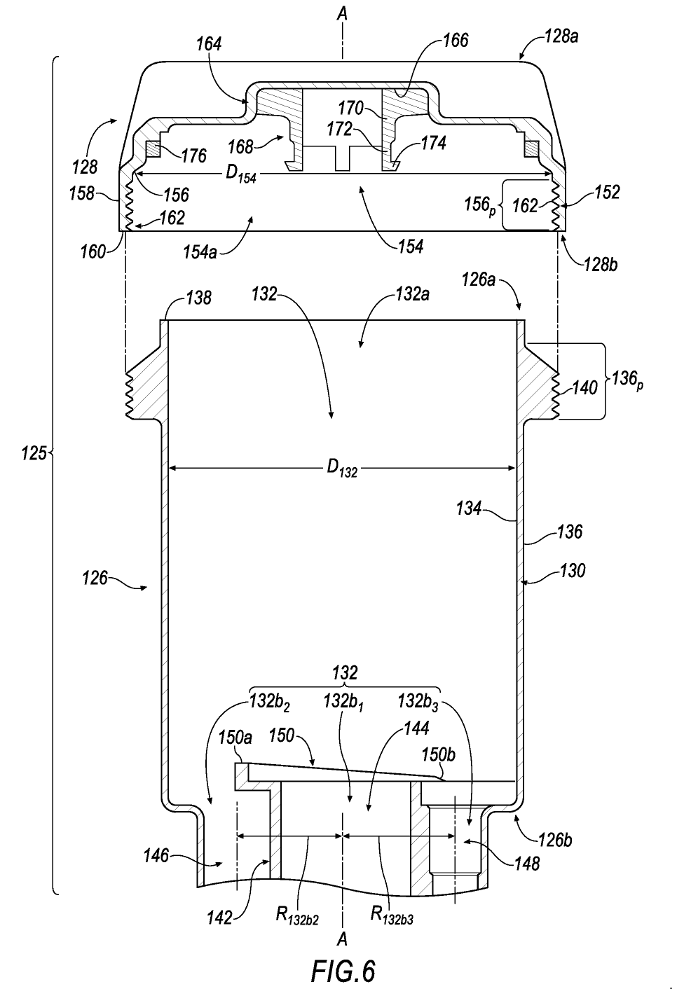

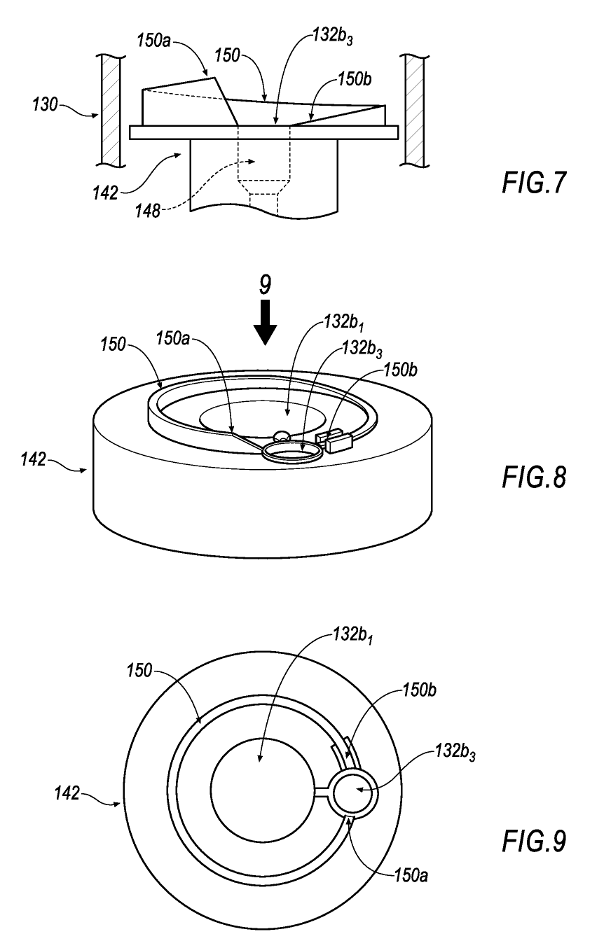

Referring to FIG. 6, a filter assembly container is shown generally at 125. The filter assembly container 125 includes a housing 126 and a lid 128. The housing 126 includes an upper end 126a and a lower end 126b. The housing 126 also includes a substantially cylindrical body 130 defining a substantially axially-centered passage 132 extending there-through that is aligned with a central axis, A-A.

The substantially axially-centered passage 132 is defined by a passage diameter D₁₃₂ extending through the substantially cylindrical body 130 from the upper end 126a to the lower end 126b. The substantially axially-centered passage 132 is further defined by an inner radial surface 134.

The substantially cylindrical body 130 is also defined by an outer radial surface 136 and an axial surface 138 that connects the inner radial surface 134 to the outer radial surface 136. A portion 136p of the outer radial surface 136 near the axial surface 138 defines an outer threaded surface 140.

Access to the substantially axially-centered passage 132 is permitted by an upper opening 132a and a lower opening 132b. The upper opening 132a is formed by the axial surface 138 at the upper end 126a of the housing 126. The lower opening 132b is formed in the lower end 126b of the housing 126. A tube-shaped stem portion 142 may extend into the substantially axially-centered passage 132 by way of the lower opening 132b formed in the lower end 126b of the housing 126; as a result, the tube-shaped stem portion 142 sub-divides the lower opening 132b into a first lower opening 132b₁, a second lower opening 132b₂ and a third lower opening 132b₃.

As seen in FIG. 6, the upper opening 132a is aligned with the central axis, A-A, and is defined by a dimension that is approximately equal to the passage diameter D₁₃₂ of the substantially axially-centered passage 132 extending through the substantially cylindrical body 130 of the housing 126. The first lower opening 132b₁ is also aligned with the central axis, A-A.

As seen in FIG. 6, the second lower opening 132b₂ is radially offset from the central axis, A-A at a radial distance R_{132b2}. As seen in FIGS. 6 and 8-9, the third lower opening 132b₃ is also radially offset from the central axis, A-A at a radial distance R_{132b3}.

Prior to insertion of the filter assembly 10, the substantially axially-centered passage 132 of the housing 126 is in fluid communication with a clean fluid discharge conduit 144, an unclean fluid intake conduit 146 and a secondary discharge conduit 148. The first lower opening 132b₁ permits the substantially axially-centered passage 132 extending through the substantially cylindrical body 130 of the housing 126 to be in fluid communication with the clean fluid discharge conduit 144. The second lower opening 132b₂ permits the substantially axially-centered passage 132 extending through the substantially cylindrical body 130 of the housing 126 to be in fluid communication with the unclean fluid intake conduit 146. The third lower opening 132b₃ permits the substantially axially-centered passage 132 extending through the substantially cylindrical body 130 of the housing 126 to be in fluid communication with the secondary discharge conduit secondary discharge conduit 148.

The tube-shaped stem portion 142 includes a spiral ramp 150 that circumscribes the first lower opening 132b₁. The spiral ramp 150 includes a high portion 150a that progressively decreases in height to a low portion 150b that is located proximate the third lower opening 132b₃.

The spiral ramp 150 may guide a close-out member (not shown) of another type of filter assembly (not shown) toward and subsequently through the third lower opening 132b₃ and into the secondary discharge conduit 148. As seen in FIGS. 1-5, the filter assembly 10 does not include a close-out member. Even though the filter assembly 10 does not include a close-out member, the filter assembly 10 is compatible with the filter assembly container 125, which will become apparent in the following disclosure at FIGS. 10A-10J.

The lid 128 includes an upper end 128a and a lower end 128b. The lid 128 also includes a substantially cylindrical body 152 defining a substantially axially-centered passage 154 extending there-through that is aligned with a central axis, A-A.

The substantially axially-centered passage 154 is defined by a passage diameter D₁₅₄ extending through the tube-shaped body 152 from approximately the upper end 128a to approximately the lower end 128b. The substantially axially-centered passage 154 is further defined by an inner radial surface 156.

The substantially cylindrical body 152 is also defined by an outer radial surface 158 and a first axial surface 160 that connects the inner radial surface 156 to the outer radial surface 158. A portion 156ₚ of the inner radial surface 156 near the first axial surface 160 defines an inner threaded surface 162.

The lid 128 also includes a recessed radial portion 164 arranged within the upper end 128a of the tube-shaped body 152. The recessed radial portion 164 defines a second axial surface 166 connected to the inner radial surface 156.

Access to the substantially axially-centered passage 154 is permitted by an opening 154a formed by the first axial surface 160 at the lower end 128b of the lid 128. A holder 168 is aligned with the central axis, A-A, and is mounted to the second axial surface 166. The holder 168 may also include a central ring portion 170 that extends toward the opening 154a and terminates with catch hooks 172 protruding axially therefrom. Each catch hook 172 may further include a flexible catch nose 174 projecting radially outwardly therefrom. A ring-shaped seal member 176 may also be attached to one or more of the inner radial surface 156 and the second axial surface 166.

An exemplary method for interfacing the filter assembly 10 with the filter assembly container 125 is now described at FIGS. 10A-10J. Referring firstly to FIGS. 10A-10C, the filter assembly 10 is firstly attached to the lid 128 of the filter assembly container 125. Then, in FIGS. 10D-10E, the lid 128 and filter assembly 10 is rotated with the lid 128 in a first direction, R, relative the housing 126 for attaching the lid 128 to the housing 126 while the filter assembly 10 is simultaneously axially disposed within the housing 126. In FIG. 10F, an exemplary view of fluid flow (i.e. F_{A}, F_{R}, F_{A}′) passing through the filter assembly 10 is shown. In FIGS. 10G-10I, the filter assembly 10 is rotated in a second direction, R′ (that is opposite the first direction, R), relative the housing 126 for detaching the lid 128 from the housing 126 and simultaneously axially removing the filtering assembly 10 from the housing 126. Then, as seen in FIG. 10J, the filter assembly 10 is detached from the lid 128.

Firstly, as seen in FIG. 10A, the holder 168 that is mounted to the second axial surface 166 of the lid 128 is axially aligned with the passage 80 extending through the tube-shaped body 78 of the first ring of memory material 16₁. The flexible catch noses 174 of the hooks 172 of the central ring portion 170 of the holder 168 are circumferentially arranged in an orientation to define an outer diameter D₁₇₄ that is greater than the passage diameter D₈₀ of the passage 80 extending through the tube-shaped body 78 of the first ring of memory material 16₁.

As seen in FIG. 10B, attachment of the lid 128 to the filter assembly 10 is commenced when the flexible catch noses 174 of the hooks 172 of the central ring portion 170 of the holder 168 are axially inserted into the passage 80 extending through the tube-shaped body 78 of the first ring of memory material 16₁ by way of the first opening 80a of the passage 80. Because the outer diameter D₁₇₄ defining the circumferential arrangement of the flexible catch noses 174 is greater than the passage diameter D₈₀ of the passage 80 extending through the tube-shaped body 78 of the first ring of memory material 16ₖ, the flexible catch noses 174 of the central ring portion 170 are permitted to flex radially inwardly as the holder 168 is axially inserted into the passage 80 extending through the tube-shaped body 78 of the first ring of memory material 16₁.

Referring to FIG. 10C, the lid 128 may be said to be attached to the filter assembly 10 when at least the hooks 172 and flexible catch noses 174 of the holder 168 pass through the second opening 80b of the passage 80. As seen in FIG. 10C, once the flexible catch noses 174 have passed through the second opening 80b, the flexible catch noses 174 may flex radially outwardly such that a portion of each flexible catch nose 174 is disposed against or “hooked” adjacent to the second axial surface 88 of the first ring of memory material 16₁. Particularly, in some instances, the each flexible catch nose 174 may be disposed against or “hooked” adjacent to the circumferential portion 88p of the second axial surface 88 of the first ring of memory material 16₁.

Referring to FIG. 10D, the lid 128 (which includes the filter assembly 10 attached thereto) is aligned with the central axis, A-A, that also extends through the housing 10 such that the filter assembly 10 may be located over the upper opening 132a of the substantially axially-centered passage 132 formed by the substantially cylindrical body 130 of the housing 126. The lid 128 may then be lowered in the direction of the arrow, L, such that the filter assembly 10 is axially inserted through the upper opening 132a and into the substantially axially-centered passage 132 formed by the substantially cylindrical body 130 of the housing 126. Lowering, L, of the lid 128 is continued until the inner threaded surface 162 of the lid 128 engages the outer threaded surface 140 of the housing 126; once the threaded surfaces 140, 162 are in contact with one another, the lid 128 may be rotated according to the direction of arrow, R, for attaching the lid 128 to the housing 126.

As the lid 128 is rotated, R, which imparts further axial lowering, L, of the filter assembly 10 within the substantially axially-centered passage 132 formed by the substantially cylindrical body 130 of the housing 126, the first axial surface 86 of the tube-shaped body 78 of the second ring of memory material 16₂ is axially advanced toward the lower opening 132b of the substantially axially-centered passage 132 formed by the substantially cylindrical body 130 of the housing 126. As seen in FIG. 10E, the first axial surface 86 of the tube-shaped body 78 of the second ring of memory material 16₂ is axially advanced at least partially through the lower opening 132b of the substantially axially-centered passage 132 formed by the substantially cylindrical body 130 of the housing 126. As the first axial surface 86 of the tube-shaped body 78 of the second ring of memory material 16₂ is axially advanced at least partially through the lower opening 132b of the substantially axially-centered passage 132 formed by the substantially cylindrical body 130 of the housing 126, the first axial surface 86 of the tube-shaped body 78 of the second ring of memory material 16₂ axially engages and conforms to one or both of: (1) the surface profile of the tube-shaped stem portion 142 that sub-divides the lower opening 132b into: the first lower opening 132b₁, the second lower opening 132b₂ and the third lower opening 132b₃ and (2) a portion of the inner radial surface 134 of the substantially cylindrical body 130 of the housing 126. Once the lid 128 has been sufficiently rotated, R (e.g., fully threadingly-secured to the housing 126 by way of the threaded surfaces 140, 162 of the housing 126 and the lid 128), the filter assembly 10 may be said to be fully axially lowered, L, within the substantially axially-centered passage 132 formed by the substantially cylindrical body 130 of the housing 126 such that a portion of the tube-shaped body 78 of the second ring of memory material 16₂ is axially lowered into and conforms to and fills and seals the third lower opening 132b₃; as a result, the second ring of memory material 16₂ prevents fluid communication of the substantially axially-centered passage 132 formed by the substantially cylindrical body 130 of the housing 126 with the secondary discharge conduit 148.

Referring to FIG. 10F, once the lid 128 has been sufficiently rotated, R (e.g., fully threadingly-secured to the housing 126 by way of the threaded surfaces 140, 162 of the housing 126 and the lid 128), the filter assembly 10 may be said to be fully axially lowered, L, within the substantially axially-centered passage 132 formed by the substantially cylindrical body 130 of the housing 126 such that fluid may flow: (1) axially into the filter assembly container 125 (see, e.g., F_{A}) in a first direction, (2) radially through the filter assembly (see, e.g., F_{R}), and (3) axially out of the filter assembly container 125 (see, e.g., F_{A}′) in a second direction opposite the first direction. Firstly, the fluid may axially flow into the filter assembly container 125 (see, e.g., F_{A}) by way of the unclean fluid intake conduit 146, through the second lower opening 132b₂ and into the substantially axially-centered passage 132 formed by the substantially cylindrical body 130 of the housing 126 and around the outer radial surface 26 of the tube-shaped body 20 of the filter media 12. Then, the fluid may radially flow through the tube-shaped body 20 of the filter media 12 by: (1) entering the tube-shaped body 20 of the filter media 12 at the outer radial surface 26, (2) through the radial thickness dimension T₂₀ of the tube-shaped body 20 of the filter media 12, (3) out of the inner radial surface 24 of the tube-shaped body 20 of the filter media 12, (4) through the plurality of radial passages 18a of the center tube 18, and (5) into the passage 22 formed by the tube-shaped body 20 of the filter media 12. Then, the fluid may axially flow out of the passage 22 formed by the tube-shaped body 20 of the filter media 12 (see, e.g., F_{A}′) through the first lower opening 132b₁ and into the clean fluid discharge conduit 144 formed by the tube-shaped stem portion 142.

Referring to FIGS. 10G-10H, the lid 128 (which includes the filter assembly 10 attached thereto) is rotated, R′, in a direction opposite the direction of the arrow, R, which imparts axial raising, L′, of the lid 128 and the filter assembly 10 away from the housing 126 such that the filter assembly 10 is axially removed from the substantially axially-centered passage 132 formed by the substantially cylindrical body 130 of the housing 126. As the filter assembly 10 is axially withdrawn from the substantially axially-centered passage 132 formed by the substantially cylindrical body 130 of the housing 126, the first axial surface 86 of the tube-shaped body 78 of the second ring of memory material 16₂ is axially advanced in the direction, L′, through (in a reverse direction opposite that as seen in FIG. 10D) the lower opening 132b of the substantially axially-centered passage 132 formed by the substantially cylindrical body 130 of the housing 126.

As seen in FIG. 10I, the first axial surface 86 of the tube-shaped body 78 of the second ring of memory material 16₂ is subsequently axially advanced away from the lower opening 132b of the substantially axially-centered passage 132 formed by the substantially cylindrical body 130 of the housing 126. As the first axial surface 86 of the tube-shaped body 78 of the second ring of memory material 16₂ is axially advanced away from the lower opening 132b of the substantially axially-centered passage 132 formed by the substantially cylindrical body 130 of the housing 126, the first axial surface 86 of the tube-shaped body 78 of the second ring of memory material 16₂ may retain a deformed surface profile resembling one or both of: (1) the surface profile of the tube-shaped stem portion 142 that sub-divides the lower opening 132b into: the first lower opening 132b₁, the second lower opening 132b₂ and the third lower opening 132b₃ and (2) a portion of the inner radial surface 134 of the substantially cylindrical body 130 of the housing 126. The maintaining of the deformed surface profile of the first axial surface 86 of the tube-shaped body 78 of the second ring of memory material 16₂ is a result of the material characteristics of the first ring of memory material 16₁/second ring of memory material 16₂; in some instances, each of the first ring of memory material 16₁ and the second ring of memory material 16₂ may comprise a polymer material. Once the lid 128 has been sufficiently rotated, R′ (e.g., fully threadingly disengaged with respect to the housing 126 by way of the threaded surfaces 140, 162 of the housing 126 and the lid 128), the filter assembly 10 may be subsequently fully axially removed from within the substantially axially-centered passage 132 formed by the substantially cylindrical body 130 of the housing 126.

Furthermore, as seen in FIG. 10I, as the filter assembly 10 is axially removed, L′, from the substantially axially-centered passage 132 formed by the substantially cylindrical body 130 of the housing 126, the portion of the tube-shaped body 78 of the second ring of memory material 16₂ is also withdrawn from and no longer fills and seals the third lower opening 132b₃. As a result, the arrangement of the second ring of memory material 16₂ axially away from the third lower opening 132b₃ permits fluid communication of the substantially axially-centered passage 132 formed by the substantially cylindrical body 130 of the housing 126 with the secondary discharge conduit 148. The secondary discharge conduit 148 may be in fluid communication with an oil pan in order to permit fluid located within the substantially axially-centered passage 132 to be axially directed (see, e.g., F_{A}″) through the third lower opening 132b₃ and into the secondary discharge conduit 148.

Referring to FIG. 10J, the filter assembly 10 may be removed from the lid 126 by, for example, applying a pulling force (according to the direction of the arrow, P) to the filter assembly 10. When the pulling force 10 is applied to the filter assembly 10, the flexible catch noses 174 may flex radially inwardly such that a portion of each flexible catch nose 174 is no longer disposed against or “hooked” adjacent to the second axial surface 88 of the first ring of memory material 16₁; particularly, in some instances, the each flexible catch nose 174 may no longer be disposed against or “hooked” adjacent to the circumferential portion 88ₚ of the second axial surface 88 of the first ring of memory material 16₁. Once each flexible catch nose 174 is no longer disposed against or “hooked” adjacent to the second axial surface 88 of the first ring of memory material 16₁, the lid 128 may be said to be detached from the filter assembly 10 by subsequently withdrawing the hooks 172 and flexible catch noses 174 of the holder 168 through the second opening 80b of the passage 80 and out of the passage 80 at the first opening 80a.

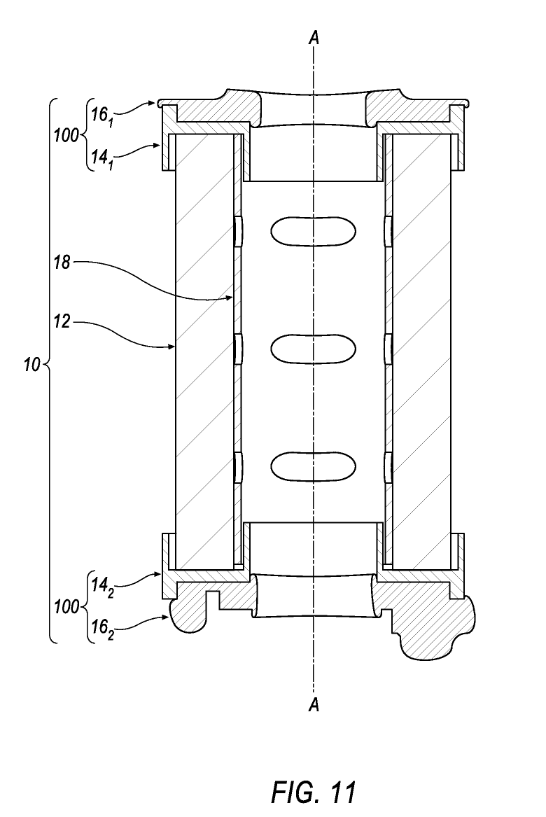

Referring to FIG. 11, the filter assembly 10 is shown fully detached from the lid 128. The first axial surface 86 of the tube-shaped body 78 of both of the first ring of memory material 16₁ and the second ring of memory material 16₂ may maintain a deformed surface profile resembling to one or more of: (1) the surface profile of the tube-shaped stem portion 142 that sub-divides the lower opening 132b into: the first lower opening 132b₁, the second lower opening 132b₂ and the third lower opening 132b₃, (2) a portion of the inner radial surface 134 of the substantially cylindrical body 130 of the housing 126, and the second axial surface 166 of the lid 128.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. An assembly, comprising:
a filter subassembly including an end cap connected to a ring of memory material, wherein the end cap includes:
a tube-shaped body defined by an inner radial surface, an outer radial surface, a first axial surface and a second axial surface, wherein the inner radial surface defines a passage extending through the tube-shaped body,
a first ring-shaped body that extends axially away from the first axial surface of the tube-shaped in a first axial direction,
a second ring-shaped body that extends axially away from a second axial surface of the tube-shaped body in a second axial direction that is opposite the first axial direction, and
a third ring-shaped body that extends axially away from the second axial surface of the tube-shaped body in the second axial direction that is opposite the first axial direction,
wherein each of the first ring-shaped body, the second ring-shaped body and the third ring-shaped body are defined by an inner radial surface, an outer radial surface and an axial surface that connects the inner radial surface to the outer radial surface,
wherein one or both of the first axial surface of the tube-shaped body and the inner radial surface of the first ring-shaped body is disposed adjacent the ring of memory material,
wherein the second axial surface of the tube-shaped body, the inner radial surface of the second ring-shaped body and the outer radial surface of the third ring-shaped body collectively define a ring-shaped filter media receiving channel.

2. The assembly of claim 1, wherein the ring of memory material includes a tube-shaped body defined by an inner radial surface, an outer radial surface, a first axial surface and a second axial surface, wherein the inner radial surface of the tube-shaped body of the ring of memory material defines a passage extending through the tube-shaped body of the ring of memory material, wherein the passage extending through the tube-shaped body of the end cap is in fluid communication with the passage extending through the tube-shaped body of the ring of memory material.

3. The assembly of claim 2, wherein the tube-shaped body of the ring of memory material is defined by a height extending between the first axial surface of the tube-shaped body of the ring of memory material and a second axial surface of the tube-shaped body of the ring of memory material, wherein the first ring-shaped body is defined by a height extending between the first axial surface of the tube-shaped body of the end cap and the axial surface of the first ring-shaped body, wherein the height of the tube-shaped body of the ring of memory material is greater than the height of the first ring-shaped body such that a circumferential portion of the outer radial surface of the tube-shaped body of the ring of memory material extends axially beyond the axial surface of the first ring-shaped body.

4. The assembly of claim 2, wherein the inner radial surface of the first ring-shaped body defines a passage extending through the first ring-shaped body, wherein the ring of memory material is partially disposed within the passage extending through the first ring-shaped body, wherein the ring of memory material defines a height dimension that is greater than a height dimension of the first ring-shaped body such that when the ring of memory material is connected to the end cap, a circumferential portion of the outer radial surface of the tube-shaped body of the ring of memory material extends axially beyond the axial surface of the first ring-shaped body.

5. The assembly of claim 2, wherein the inner radial surface of the first ring-shaped body defines a passage extending through the first ring-shaped body, wherein the passage extending through the first ring-shaped body is defined by a diameter, wherein the outer radial surface of the tube-shaped body of the ring of memory material defines an outer diameter of the tube-shaped body of the ring of memory material, wherein the outer diameter of the tube-shaped body of the ring of memory material is approximately equal to but less than the diameter of the passage extending through the first ring-shaped body.

6. The assembly of claim 2, wherein a circumferential portion of the second axial surface of the tube-shaped body of the ring of memory material is arranged in a cantilevered orientation with respect to the first axial surface of the tube-shaped body of the end cap.

7. The assembly of claim 1, wherein the outer radial surface of the first ring-shaped body and the outer radial surface of the second ring-shaped body are connected to and axially aligned with the outer radial surface of the tube-shaped body of the end cap.

8. The assembly of claim 1, wherein the inner radial surface of the third ring-shaped body is connected to and is aligned with the inner radial surface of the tube-shaped body of the end cap.

9. The assembly of claim 8, wherein the inner radial surface of the third ring-shaped body defines a passage extending through the third ring-shaped body, wherein the passage extending through the third ring-shaped body is axially aligned with and is in fluid communication with the passage extending through the tube-shaped body of the end cap.

10. A filter assembly, comprising:
filter media including a tube-shaped body defined by an inner radial surface, an outer radial surface, a first axial surface and a second axial surface, wherein the inner radial surface defines a passage extending through the tube-shaped body of filter media, wherein the first axial surface and a portion of each of the inner radial surface and the outer radial surface extending from the first axial surface defines a first end of the tube-shaped body of filter media, wherein the second axial surface and a portion of each of the inner radial surface and the outer radial surface extending from the second axial surface defines a second end of the tube-shaped body of filter media;
a first filter subassembly of claim 1 disposed adjacent the first end of the tube-shaped body of the filter media; and
a second filter subassembly of claim 1 disposed adjacent the second end of the tube-shaped body of the filter media.

11. The filter assembly of claim 10, wherein the first end of the tube-shaped body of the filter media is disposed within and connected to the ring-shaped filter media receiving channel of the first filter subassembly, wherein the second end of the tube-shaped body of the filter media is disposed within and connected to the ring-shaped filter media receiving channel of the second filter subassembly.

12. The filter assembly of claim 10 further comprising:
a center tube, wherein the center tube is disposed within the passage extending through the tube-shaped body of the filter media, wherein the center tube is disposed substantially adjacent the inner radial surface of the tube-shaped body of the filter media, wherein the center tube includes a plurality of radial fluid-flow passages.

13. An assembly, comprising:
the filter assembly of claim 10; and
a lid connected to the filter assembly, wherein the lid includes a holder that is mounted to an inner axial surface of the lid, wherein the holder includes a central ring portion that terminates with a plurality of catch hooks each having a radially-outwardly-projecting flexible catch nose, wherein the central ring portion is disposed within a passage extending through a tube-shaped body defining the ring of memory material of the first filter subassembly, wherein the radially-outwardly-projecting flexible catch nose of each catch hook of the plurality of catch hooks is disposed adjacent a circumferential portion of a second axial surface of the tube-shaped body of the ring of memory material of the first filter subassembly, wherein the circumferential portion of the second axial surface of the tube-shaped body of the ring of memory material of the first filter subassembly is arranged in a cantilevered orientation with respect to the first axial surface of the tube-shaped body of the end cap of the first filter subassembly.

14. A filter, comprising:
a housing includes a substantially cylindrical body defining a passage;
the lid of claim 13 connected to the housing; and
the filter assembly of claim 13 disposed within the passage defined by the substantially cylindrical body of the housing.

15. The filter of claim 14, wherein a tube-shaped body defining the ring of memory material of the second filter subassembly engages and conforms to a surface profile of a tube-shaped stem portion extending through a lower opening of the substantially cylindrical body of the housing.

16. The filter of claim 15, wherein a portion of the tube-shaped body of the ring of memory material of the second filter subassembly is axially lowered into and conforms to and fills and seals an opening defined by the tube-shaped stem portion that is in fluid communication with a secondary discharge conduit.

17. A method, comprising:
assembling a filter assembly by
arranging a first subassembly including a first end cap connected to a first ring of memory material adjacent a first end of a tube-shaped body of filter media, and
arranging a second subassembly including a second end cap connected to a second ring of memory material adjacent a second end of the tube-shaped body of the filter media;
removably-connecting the filter assembly to a lid by joining the lid to the first subassembly of the filter assembly;
while the lid is connected to the filter assembly, axially disposing the filter assembly into an upper opening defined by a passage of a housing by firstly inserting the second subassembly through the upper opening and into the passage defined by the housing and subsequently rotatably-connecting the lid to the housing;
as the lid is rotatably-connected to the housing, the second ring of memory material of the second subassembly is further axially advanced into the passage defined by the housing for engaging and conforming to a surface profile of a tube-shaped stem portion extending through a lower opening of the housing for
conforming to and filling and sealing at least one lower opening of a plurality of lower openings defined in part by the tube-shaped stem portion that is in fluid communication with a secondary discharge conduit.

18. The method of claim 17, wherein the removably-connecting further includes:
disposing a central ring portion that extends from inner axial surface of the lid within a passage extending through a tube-shaped body defining the first ring of memory material; and
disposing a radially-outwardly-projecting flexible catch nose of each catch hook of a plurality of catch hooks extending from the central ring portion adjacent a circumferential portion of a second axial surface of the tube-shaped body of the first ring of memory material, wherein the circumferential portion of the second axial surface of the tube-shaped body of the first ring of memory material is arranged in a cantilevered orientation with respect to a first axial surface of a tube-shaped body of the first end cap.

19. The method of claim 17, wherein the plurality of lower openings includes a first lower opening, a second lower opening and a third lower opening, wherein the second ring of memory material of the second subassembly conforms to and fills and seals the third lower opening, wherein the first lower opening permits the passage defined by the housing to be in fluid communication with a clean fluid discharge conduit, wherein the second lower opening permits the passage defined by the housing to be in fluid communication with an unclean fluid intake conduit, wherein the third lower opening permits the passage defined by the housing to be in fluid communication with the secondary discharge conduit secondary discharge conduit.

20. The method of claim 19, wherein the tube-shaped stem portion includes a spiral ramp that circumscribes the first lower opening, wherein the second ring of memory material of the second subassembly engages and conforms to a surface profile of the spiral ramp as the second ring of memory material of the second subassembly is further axially advanced into the passage defined by the housing as a result of the lid being rotatably-connected to the housing.
